(19) United States
(12) Patent Application Publication
(10) Pub. No.: US 2003/0198729 A1
(43) Pub. Date: Oct. 23, 2003

(54) Process for sterilizing a food product with a low water content, a food product obtained thereby and a food composition containing it

(76) Inventors: Benoit Fuhrmann, Les-Essarts-Le-Roi (FR); Jean-Luc Rabault, Breuillet (FR)

Correspondence Address: FINNEGAN, HENDERSON, FARABOW, GARRETT & DUNNER, LLP, 1300 I STREET, NW, WASHINGTON, DC, 20005, US

(21) Appl. No.: 10/424,106

(22) Filed: Apr. 28, 2003

Related U.S. Application Data
(63) Continuation of application No. 09/744,480, filed on Mar. 9, 2001, now abandoned.
Application No. 09/744,480 is a 371 of international application No. PCT/FR99/01878, filed on Jul. 29, 1999.

(30) Foreign Application Priority Data
Jul. 31, 1998 (FR) 98 09847

(51) Int. Cl. A23C 1/00

(52) U.S. Cl. 426/631

(57) ABSTRACT

The invention relates to a process for sterilizing a food product with a low water content, the food product being contaminated by microorganisms, in particular chocolate or a chocolate analogue, the process being remarkable in that the water activity (A_{w}) of said food product is raised to a value of more than about 0.7, preferably more than 0.8, in that the hydrated food product undergoes a thermal sterilization step and in that water is eliminated so as to recover an essentially sterile food product with a low water content with a contamination, in particular of sporulaceous bacteria, at least 1000 times lower (log 3) than the contaminated starting product, and in particular less than 1 CFU/g. The invention also relates to the sterilized food product and food compositions comprising said product.

The present invention relates to a process for sterilizing a naturally or artificially contaminated food product with a low water content. It also relates to the essentially sterile food products obtained thereby, and to food compositions containing said food products.

Certain ingredients and foods with a low water content, defined by the water activity A_{w}<0.60, of nutritional, organoleptic, or technological interest, can form part of the composition of food products. Examples are chocolate, sugars (sucrose or others), naturally dry fruit (hazelnuts, almonds, etc.), artificially dried fruit (banana chips, etc.), biscuits or other cereal products, powders (milk and its derivatives, mixtures of powdered ingredients, etc.), spices, etc.

Such non-sterile ingredients can alter the commercial and hygienic quality of the finished product. As an example, adding chocolate can contaminate the finished product, in particular with sporulaceous bacteria; the same is true when adding sugar or nuts to a fresh product that cannot tolerate final sterilization.

A number of processes that can produce the required sterility are known for sterilizing aqueous food compositions, in particular milk-based food compositions.

However, when such aqueous compositions contain substances that are contaminated by nature, in particular chocolate, when they come into contact with water, the bacteria present in the solid particles develop and contaminate the aqueous composition and affect the microbiological stability thereof.

In the case of chocolate, this disadvantage is all the more significant when that ingredient constitutes a major additive often associated with food compositions.

For that reason, processes have already been proposed with the aim of sterilizing chocolate.

European patent EP-B-0 615 692, for example, describes a process for sterilizing chocolate by heating to a temperature in the range 110° C. to 130° C. for 10 to 30 minutes. That process can sterilize chocolate only because of its low sugar content (<10%). Similarly, European patent application EP-A-0 770 332 describes a similar sterilization process in which the chocolate mass is heated to a temperature of close to 125° C. for 5 to 10 minutes.

However, such processes only result in limited sterilization of the order of log 2, i.e., the quantity of contaminating microorganisms, in particular sporulaceous bacteria, is reduced by only 100.

Further, conventional anti-microbial heat treatment technologies can modify the nutritional, organoleptic or technological qualities of the treated foods and ingredients. In addition, certain microorganisms (in particular sporulaceous bacteria) in a protective environment (for example low A_{w}, high fat content) require heat treatment conditions that are incompatible with industrial reality.

Recently, new processes have been studied, such as those involving high pressure, pulsed electrical fields, resistance heating, ionization, infrared, ultraviolet, ultrasound, etc.

Such processes are limited to dry ingredients, and the compromise between anti-microbial effectiveness and maintaining organoleptic qualities is not always satisfactory.

The minimum contamination proposed for dry ingredient suppliers is of the order of 100 colony forming units per gram (CFU/g). With a maximum reduction of log 2, prior art purification provides about 1 CFU/g. That is incompatible with use in aqueous food compositions, more especially when A_{w} is high.

Thus the proposal of a further sterilization process that can substantially reduce the quantity of microorganisms in “dry” ingredients and foods, in particular chocolate, while preserving organoleptic properties, is desirable.

In summary, a proper sterilization process must satisfy certain criteria:

maintain the nutritional, organoleptic or technological benefit of the treated ingredient;

satisfactorily reduce microbial flora (yeasts, molds, vegetative and sporulaceous bacteria, etc.) relative to the preservation requirements of the finished products throughout their normal service life;

nutritional compatibility of the process and the elements being treated;

cost compatible with the value of the finished product;

possibility of industrialization, etc.

In a first aspect, the invention provides a process for sterilizing a naturally or artificially contaminated food product with a low water content, characterized in that the water activity (A_{w}) of said food product is raised to a value of more than about 0.7, preferably more than 0.8, in that the hydrated food product undergoes a thermal sterilization step and in that water is eliminated so as to recover an essentially sterile food product with a low water content with a contamination, in particular of sporulaceous bacteria, at least 1000 times lower (log 3) than the contaminated starting product, and in particular less than 1 CFU/g.

Preferably, the water activity is raised to a value of more than 0.87, in particular in the range 0.9 to 0.96.

Preferably, the whole process is carried out batchwise in the same vessel.

Depending on the A_{w}, the temperature, and the heat treatment period, the process of the invention can reduce micro-organisms by an amount in the range log 3 to log 12 (1000 to 1012 times less), in particular in the range log 3 to log 9, and preferably at least log 5 for sporulaceous bacteria, advantageously at least log 6. By taking the initial contamination of the ingredients into account (about 100 to 10000 spores per gram), this can produce an “essentially sterile” product containing less than 1 CFU/g, preferably less than 1 CFU/100 g and more preferably less than 1 CFU/kg.

The water activity of a product is a concept that is well known in the food industry. This ratio, abbreviated to A_{w}, is a measure of the availability of water in a sample. In the majority of cases, this water activity is not proportional to the water content of a product.

By way of example, fruit yogurt comprises 82% water and has an A_{w} of 0.99; low fat fromage frais contains 87% water and has an A_{w} of 0.99.

Methods enabling the A_{w} of a product to be measured are known to the skilled person. The A_{w} is generally measured at 25° C.

More particularly, the invention relates to the sterilization of products with an A_{w} of less than 0.6, and in particular of the order of about 0.4; the following can be cited: chocolate or chocolate analogue; naturally dry fruits; sugars; artificially dried fruits; biscuits or other cereal products; powders (milk and its derivatives, mixtures of powdered ingredients); and spices.

One advantage of the process of the invention is that it very substantially reduces contamination by sporulaceous bacteria. Conventional pasteurization processes can eliminate vegetative bacteria but not sporulaceous bacteria.

The term “chocolate analogue” means any confectionery fat mass containing a continuous fat phase constituted by one or more fats of vegetable or animal origin, the properties of which are similar to those of cocoa butter (generally termed “compound”), or are plastic at 20° C. (spreads, cream fondants and pralines).

Sugar (sucrose) can also be replaced by a known sweetening agent of the polyol or acesulfame K type. Non fat cocoa solids that are at least partially replaced by the usual constituents of chocolate confectionery are also included in the definition of “chocolate analogue”.

The process of the invention is particularly suitable for treating dark chocolate. This is defined in law and generally comprises at least 30% cocoa (in the form of dry defatted cocoa and/or cocoa butter), of which at least 2.5% is dry defatted cocoa; the quantity of powdered milk is 5% or less.

However, the invention is also suitable for producing different essentially sterile types of milk or white chocolate. As an example, it is known that white chocolate generally contains 30% to 35% of cocoa butter, but contains no dry defatted cocoa.

To hydrate the low water content product in accordance with the invention to reach the target A A_{w}, the required water is either all added at the beginning, or partially at the beginning and partially during heating to the sterilization temperature of the product, or only during heating. This addition of water during heating is preferably carried out by direct injection of food quality steam into the product.

Pure water can be added, or aqueous compounds can be added, such as milk (skimmed or otherwise, concentrated or otherwise), cream or other milk products, fruit juices, etc.

The A_{w} is measured as follows and is known as the equivalent A_{w}:

A proportion of water corresponding to total moisture of a product with a low water content at the end of the sterilization stage (added water+condensed vapor) is added to that product in a suitable laboratory mixer. It is stirred for 15 minutes at 50° C., avoiding any evaporation, and it is allowed to stand at 20° C. in a closed vessel containing very little head space. After 24 hours, the product is reduced to a fine powder or is mixed (depending on its consistency) and its A_{w} is measured at 25° C. using a conventional Aqualab CX-2 or Decagon apparatus.

In the particular case of products in pieces (chopped hazelnuts, etc.), the start of this procedure is adapted: water is added by injecting steam for better distribution, and it is stirred for 1 hour at 50° C.; then the procedure is completed as above.

In the case of products other than chocolate or a chocolate analogue, the water activity is increased by simple hydration by the aqueous phase.

For sugar, where water activity is less than 0.3, or naturally dry fruits where water activity is less than about 0.6, the mixture is produced in a suitable proportion to obtain an A_{w} at 25° C. of about 0.7, advantageously more than 0.8, preferably more than 0.87. very fatty dry fruits that absorb little water are preferably immersed in an excess of water, which is then drained off after sterilization and before evaporation.

In contrast, water is known to be incompatible with chocolate as water increases its viscosity exponentially until it solidifies. In fact, the viscosity of chocolate increases to a peak and then reduces depending on the water content. This phenomenon occurs both when hydrating and when dehydrating chocolate. This rheological peak is also substantially smaller for chocolate than for cocoa paste.

Unexpectedly, it has been discovered that adjusting the amount of fat can prevent the viscosity from becoming too high during hydration or dehydration. In fact, the intensity of the Theological peak is also correlated with the amount of fat in the chocolate or chocolate analogue. For normal to high fat contents, the viscosity of the water+chocolate mixture reduces as the amount of fat increases. For small quantities of fat, the texture of water and chocolate mixture is no longer that of a liquid paste but of a powder.

For the same amount of added water, for example 10%, the chocolate+water mixture can thus have different textures, depending on the amount of fat in the dry chocolate: if the fat content is in the range 28% to 48%, the mixture is a highly viscous, almost solid paste; for a fat content of less than 28%, the product has the consistency of a powder, which is easier to mix: if the fat content is higher than 48%, the mixture remains very fluid.

For this reason, in a first preferred variation, the chocolate undergoing the hydration step comprises at least 48% fat, preferably between 48% and 90%, in particular between 48% and 70% fat.

In a second variation, it has been discovered that a chocolate or chocolate analogue wherein the fat content is less than 28% can also achieve the desired aim. Preferably, in this variation, the chocolate or chocolate analogue comprises between 20% and 28% fat.

In the latter case it is usually desirable for the percentage of sterilized fat required to recover a chocolate with a conventional composition to be added at the end of the process.

Thus in a preferred variation, a process for sterilizing a food product with a low water content is characterized in that the water activity of the chocolate or chocolate analogue is raised to a value of more than about 0.87 by mixing a chocolate or chocolate analogue containing less than about 28% by weight of fat or by mixing a chocolate or chocolate analogue containing more than about 48% by weight of fat with an aqueous phase to obtain a homogeneous paste.

It is also possible to carry out hydration by mixing a mass of chocolate or chocolate analogue in a water-in-oil emulsion base formed from a fat, an emulsifying agent and water as described in European patent EP-A-0 832 567.

Once the hydrated product is obtained, degassing is preferably carried out followed by a sterilization step carried out at a temperature generally in the range 100° C. to 150° C., for a suitable period, in particular 1 minute to 10 minutes.

In one aspect, hydration is carried out by adding the whole quantity of water required to reach the target A_{w} at once.

Sterilization heating is preferably achieved by direct injection of food quality steam. The sum of the water added at the start plus the vapor condensed during heating contributes to increasing the A_{w}. The quantity of steam injected into the product is preferably measured using a mass flow meter.

In one implementation of the invention, the hydrated and degassed product is advantageously heated, prior to sterilizing, for 10 minutes at 80° C., then 20 to 60 minutes in the range 30° C. to 37° C., in particular to encourage homogeneous distribution of the A_{w} in the product, which improves the sterilization efficiency, especially if carried out by steam injection, and also when employing pieces.

The skilled person will adjust the value of the A_{w}, the temperature, and the treatment period as a function of the ingredients, the nature of the contamination, and the equipment. The same level of sterilization can be obtained with a different combination of these parameters. As an example, if the A_{w} of the product to be sterilized is increased, the time/temperature couple can be reduced. For stronger products, the treatment can be carried out at an A_{w} of close to 0.65. In general, for an A_{w} of 0.7 to 0.8, the process involves treatment at 125° C. to 130° C. for 4 minutes to 1.8 hours (h) (preferably for 5 to 30 minutes) or at a temperature of 145° C. to 150° C. for about 30 seconds to 5 minutes, in particular 30 seconds to 60 seconds, preferably 1 minute to 5 minutes.

The sterilization period is generally in the range 15 seconds to 4 minutes for a temperature of about 125° C. to 135° C. and an A_{w} of more than 0.9. The periods are longer for fatty ingredients (chocolate, nuts, etc.) as compared with non fatty products (sugar, etc.), as the fat renders the micro-organisms more heat resistant.

Certain ingredients such as sugars can tolerate long periods at low temperatures; others such as chocolate are preferably treated above 120° C. for a shorter period.

Preferably, the chocolate is sterilized in batches, with an equivalent A_{w} of 0.82 to 0.95, heating from 50° C. by direct injection of food quality steam to a temperature in the range 125° C. to 135° C., then holding that temperature for 2 to 8 minutes. Preferably, steam injection is preceded by intense degassing (about −0.95 bars).

The water is then eliminated, preferably by vacuum evaporation at a suitable temperature, in particular of the order of 80° C.

During dehydration, the viscosity of the chocolate or chocolate analogue paste varies depending on its fat content. For a fat content of more than 48%, the viscosity at 40° C., measured using the Casson method with a Haake VT500 viscosimeter, does not exceed about 15 Pascal.seconds (Pa.s) regardless of the amount of water added. In the case of chocolate or chocolate analogue with a fat content of less than 28%, a powder is obtained rather than a viscous paste.

The process can be applied to a chocolate or chocolate analogue comprising 28% to 48% fat. However, at these fat contents, the viscosity measured at the Theological peak is more than 20 Pa.s and usually becomes infinite (solid product). In this case, a more powerful mixer with a higher shear is required to prevent setting during dehydration, especially if a lot of water has been added.

During this evaporation, crystallization of sugars is observed and they can form agglomerates with cocoa and milk particles. Preferably, the particles, in particular sugar crystals, should not be more than 30 micrometers in size.

It should be noted that the process is particularly remarkable in the case of chocolate or chocolate analogue in accordance with the first or second variation in that it requires proportions of fat beyond that of the normal quantities.

Clearly, it is possible to subsequently re-adjust the fat content to obtain conventional chocolate or chocolate analogue.

The products obtained have an organoleptic profile that is substantially similar to standard products and in particular, they do not have the “burned” taste obtained when sterilization is carried out in a conventional manner.

Depending on the selected parameters, in particular A_{w}, temperature, period, the sterilized products obtained exhibit a reduction in micro-organisms in the range log 3 to log 12, normally in the range log 3 to log 9, preferably at least log 5 for sporulaceous bacteria.

In other words, the contamination of these products is less than 1 CFU/g, preferably less than 1 CFU/100 g, advantageously less than 1 CFU/kg.

The invention also provides a food product originating from a food product with a low water content, contaminated by micro-organisms, characterized in that it is essentially sterile, in that it can be obtained by the process described above and in that its contamination, in particular in sporulaceous bacteria, is at least 1000 times lower than said naturally or artificially contaminated starting product, in particular less than 1 CFU/g, preferably less than 1 CFU/100 g, and advantageously less than 1 CFU/kg.

In a variation, this food product is chocolate or a chocolate analogue.

The invention is also remarkable in that the chocolate or chocolate analogue can be in the form of pieces (chips, etc.), in particular more than 4 millimeters (mm) in size, to enable consumers to recognize and appreciate the taste of chocolate especially when these pieces are incorporated into a food composition.

In a first implementation of the invention, the pieces of chocolate or chocolate analogue form a discontinuous layer more than 2 centimeters (cm) wide and less than 5 mm thick.

It should also be noted that the sugar content of the chocolate or chocolate analogue of the invention is sufficient to overcome the inherent bitter taste of cocoa.

A typical composition of a chocolate or chocolate
analogue of the invention comprises:

| | |
|---|---|
| dry and defatted cocoa | 0 to 35% |
| cocoa butter or fat | 20% to 90% |
| sugar or the like | 10% to 65% |
| powdered milk, skimmed or otherwise | 0 to 30% |

Like all chocolate or chocolate analogues, it can also comprise flavoring and one or more emulsifying agents such as lecithin or PGPR (polyglycerol polyricinoleate).

A typical composition of conventional dark chocolate
comprises, as a percentage by weight:

| dry and defatted cocoa | 15% to 35% |
|---|---|
| cocoa butter | 28% to 43% |
| sugar or the like | 23% to 60% |
| powdered milk | <5% |

A typical couverture chocolate comprises:

| | |
|---|---|
| dry and defatted cocoa | 2.5% to 30% |
| cocoa butter | 31% to 43% |
| sugar or the like | 27% to 65% |
| powdered milk | <5% |

A typical milk chocolate composition comprises, as a
percentage by weight:

| | |
|---|---|
| dry and defatted cocoa | 2.5% to 7% |
| cocoa butter | 28% to 36% |
| sugar or the like | 40% to 50% |
| powdered milk | 14% to 21% |

A typical white chocolate composition comprises, as
a percentage by weight:

| | |
|---|---|
| cocoa butter | 21% to 30% |
| sugar or the like | 40% to 60% |
| powdered milk | 14% to 30% |

The invention also provides a food composition formed from an aqueous phase, in particular a continuous phase, more particularly milk based, and sterile food products as defined above, in particular chocolate or a chocolate analogue as a mixture or in pieces.

The expression “pieces of chocolate or chocolate analogue” means solid particles with a grain size sufficient to endow them with the characteristic chocolate taste of this substance. These particles are thus differentiated from smaller chocolate-based ingredients that are already in use, that have been sterilized in such a manner that the taste has been substantially modified, and that are present only to give the composition a chocolate-like appearance. These ingredients cannot be “pieces” as regards size since in this case the disagreeable taste would be noticed by the consumer.

In particular, the invention provides food compositions with a “neutral” or weakly acidic pH, in particular desserts, in which a bacterial contamination, in particular sporulaceous contamination, can develop. Preservation of microbiological stability constitutes a remarkable advantage of the compositions of the invention although the pH region is favorable to the development of micro-organisms. This sporulaceous bacteria development is very difficult in acidic products.

The water activity of these food compositions is also more than 0.80, advantageously 0.85 or 0.90, beyond which bacteria can develop.

In particular, they are milk based products which may be whipped in the form of an oil-in-water emulsion and which also contain one or more fats of milk or animal origin, one or, more sugars and one or more emulsifying agents.

It is also possible to use hydrogenated or non hydrogenated vegetable fats.

The composition can also comprise milk powder.

An example of a cream dessert in accordance with the invention is given below:

| fresh milk | 70% to 85% |
|---|---|
| powdered milk | 0 to 5% |
| AMF | 0 to 2% |
| Sugar | 4% to 12% |
| texturing agents | <2.5% |
| caramel | <10% |

and 1% to 10% with respect to the milk base of sterilized solid particles as described above.

The dry extract is advantageously in the range 0.20 to 0.34 and has an A_{w} of about 0.98. The pH is in the range 6 to 7.

Sterilized products of the invention, in particular chocolate or chocolate analogues, are also suitable for preparing a neutral pH mousse.

The food composition can also be enrobed in a known manner.

The following examples illustrate the invention.

### EXAMPLES 1 TO 6

### Production of an Essentially Sterile Chocolate

The following ingredients were added to a thermostatted mixer: water, cocoa paste, sugar, deodorized cocoa butter, possibly milk powder containing 26% fat, powdered milk containing 0% fat, cream containing 40% fat.

The table summarizes the compositions prepared (Examples 1 to 6),

| Example | 1 | 2 | 3 | 4 | 5 | 6 |
|---|---|---|---|---|---|---|
| Water | 34.0 | 29.6 | 34.0 | 28.6 | 30.3 | 26.5 |
| Cocoa paste | 17.0 | 12.4 | 9.7 | 9.7 | 7.0 | 7.0 |
| Sugar | 40.0 | 29.7 | 33.5 | 33.4 | 24.4 | 24.4 |
| Deodorized | 9.0 | 28.3 | 8.8 | 8.8 | 28.4 | 28.4 |
| cocoa | | | | | | |
| butter | | | | | | |
| Powdered | | | 14.0 | | 9.9 | |
| milk, | | | | | | |
| 26% fat | | | | | | |
| Powdered | | | | 10.4 | | 7.3 |
| milk, | | | | | | |
| 0% fat | | | | | | |
| Cream, | | | | 9.1 | | 6.4 |
| 40% fat | | | | | | |
| TOTAL | 100.0 | 100.0 | 100.0 | 100.0 | 100.0 | 100.0 |
| % fat/DM | 27.6 | 49.8 | 27.0 | 27.0 | 50.1 | 50.1 |
| H₂O % | 34.0 | 29.6 | 34.4 | 34.4 | 30.6 | 30.6 |
| Starting A_{w} | 0.90 | 0.90 | 0.88 | 0.88 | 0.90 | 0.90 |

The starting chocolate compositions contained less than 1% of water and had an A_{w} of less than 0.6. The ingredients were contaminated with Bacillus type sporulaceous bacteria, about 10 to 10000 CFU/g, typically 500 CFU/g for cocoa paste and milk.

The ingredients were melted and mixed between 40° C. and a maximum of 50° C. to prevent foaming on degassing.

The sugar dissolved completely. The mixtures were placed under high vacuum at −0.09 MPa (−0.9 bar) for degassing, to facilitate sterilization in the ingredient core, to prevent oxidation of the fats during heating and to prevent foam formation during evaporation.

It was rapidly pre-heated to 100° C. by the double envelope and food quality steam was injected directly into the product up to 127° C. then injection was stopped and the product was held at this temperature for 1 minute to 4 minutes; this allowed pressure sterilization without allowing the water to evaporate.

The A_{w} increased to over 0.90 during steam injection. The equivalent A_{w} was then about 0.95.

It was rapidly cooled to 85° C. using the double envelope or by placing under vacuum to stop aromatic compound evolution, and a reduction of log 6 (base 10) was observed, namely 1 million times.

The water was then evaporated off from the product by the double envelope under a vacuum of about −0.09 MPa (−0.9 bars) to a water content of less than 1% or A_{w}<0.30, then it was cooled to 45° C.

For Examples 1, 3 and 4 (27% fat), all of the sterilized cocoa butter was added to obtain the desired fat content.

Depending on the desired sugar crystal size, during evaporation and cooling, the sterile composition was sheared at a high rate, for example using a colloid mill, to limit the crystal size to 30 micrometers (μm) to 60 μm. This constitutes a preferred variation.

In a further variation, the mixer does not shear at such a high rate and the largest particles, in particular those more than 30 μm, must be ground in a sterile manner, for example using a ball mill.

The chocolates obtained had an organoleptic profile that was similar to a conventional chocolate without a burned taste and with microbial contamination of less than 1 CFU/kg of chocolate, corresponding to a reduction of log 6 both for natural contamination and after artificially seeding with Bacillus subtilis.

All of these operations can be carried out in batches in a mixer or continuously (for example sterilization using a scraped surface heat exchanger, then thin layer vacuum drying), or by a combination of the two (for example continuous sterilization using a scraped surface heat exchanger, then batchwise vacuum evaporation).

### EXAMPLE 7

### Reduction of Microbial Flora in Sugar

Sugar contains less than 1% water and its A_{w} is <0.3. It is contaminated by Bacillus type sporulaceous bacteria in an amount of about 5 to 50 CFU/g, typically 15 CFU/g.

Water and sugar were mixed at 50° C. to obtain an A_{w} at 25° C. of >0.90, and it was degassed.

Pressurized heat treatment was carried out for 1 to 4 minutes/127° C. then evaporated, bringing the vacuum to about −0.09 MPa (−0.9 bar), to an A_{w} of <0.3 and the sugar was crystallized (a portion could remain amorphous). It was packaged under “ultra-clean” conditions.

Double envelope heating is not effective for powders: in a preferred variation, a vessel was used with a microwave generator to provide the energy for evaporation, while remaining under vacuum.

The sugar obtained regained its starting characteristics, in particular an A_{w} of <0.3, with a grain size that could be modified as regards the standard; its microbial contamination was then less than 1 CFU/1000 g of sugar.

All these operations could be carried out batchwise in a mixer, or continuously (for example, sterilization using plate exchangers, then drying in a spray tower with sterile filtered air; then optional finishing with a fluidized bed drier).

### EXAMPLE 8

### Reduction of Microbial Flora in Naturally Dry Fruits (Hazelnuts, Almonds, etc.)

Naturally dry fruits, roasted or otherwise, contain less than 7% water and have an A_{w} of <0.6. They are contaminated with Bacillus type sporulaceous bacteria, in an amount of about 5 to 50 CFU/g.

The whole, crushed or pasted dry fruits were mixed at 50° C. with water to obtain an A_{w} at 25° C. of >0.90 and it was degassed. In a variation, pieces of the fruit were immersed in excess water. It was heat treated for 1 minute to 4 minutes at 127° C. under pressure, preferably by direct injection of food quality steam.

The free water was drained off (when the fruit was in pieces) then evaporated off, under a vacuum of about −0.09 MPa (−0.9 bar) to dry to an A_{w} of <0.3.

It was packaged under “ultra-clean” conditions.

The dry fruit obtained regained their initial characteristics, in particular their crispness (which may even have been improved if they had been dried out more than the initial fruit) and an A_{w} of <0.6, with a grain size that can be modified as regards the standard; the microbial contamination was then less than 1 CFU/kg.

All these operations could be carried out batchwise in a mixer.

### EXAMPLE 9

### Reduction of Microbial Flora in Milk Chocolate

The starting chocolate had the following composition:

| | Choc 9 |
|---|---|
| Cocoa paste | 9.0 |
| Sugar | 35.1 |
| Cocoa butter | 40.6 |
| Milk powder, 0% fat | 10.4 |
| AMF | 3.7 |
| Lecithin | 0.6 |
| PGPR | 0.5 |
| Flavors | 0.1 |
| Total | 100.0 |
| % fat/DM | 50 |

AMF anhydrous milk fat
DM = dry matter

Its water content was <0.5% and its A_{w} was 0.3.

It was artificially contaminated with spores of a strain of Bacillus subtilis isolated from cocoa. The freeze-dried spores were homogeneously dispersed in the melted chocolate at 50° C.

The process was carried out in a sterile pressure- and vacuum-resistant mixer equipped with a double envelope, a wall scraping mixer blade and a colloid mil

The chocolate was intimately mixed at 50° C. with 15% water. It was degassed by placing under vacuum (−0.95 bar).

It was rapidly heated to 95° C. using a double envelope and held for 8 minutes. It was then heated to 126° C. under pressure by direct injection of food grade steam, then injection was halted and the product was kept at this temperature for 3 minutes to sterilize it. The equivalent A_{w} of the chocolate during sterilization was 0.82.

The water was evaporated off at −0.95 bar, supplying the energy via a double envelope, until the initial A_{w} and moisture content was regained, then it was cooled to 50° C. During evaporation and/or cooling, the agglomerates that were formed were ground using a colloid mill: a final fineness in the range 60 μm to 100 μm was obtained, measured using a micrometer, using a well known chocolate making method.

If needed, the chocolate could then be ground more finely to obtain conventional finenesses in the range 15 μm to 45 am, preferably about 20 μm, by passage through a sterile ball mill.

Sterilization reduced the Bacillus subtilis contamination by log 4.2 compared with the seeded starting chocolate.

Thus, a milk chocolate was obtained with characteristics that were identical to the initial characteristics, but essentially sterile.

### EXAMPLE 10

### Reduction of Microbial Flora in Milk Chocolate

The starting chocolate had the following composition:

| | Chocolate 10 |
|---|---|
| Cocoa paste | 9.00 |
| Sugar | 35.10 |
| Cocoa butter | 41.15 |
| Milk powder, 0% fat | 10.40 |
| AMF | 3.70 |
| Lecithin | 0.30 |
| PGPR | 0.25 |
| Flavors | 0.10 |
| Total | 100.0 |
| % fat/DM | 50 |

Its water content was less than 0.5% and its A_{w} was 0.3.

Its natural contamination was 1100 CFU/g, with 86 spores of mesophilic aerobic bacteria (at 30° C.)/g.

Two tests were carried out: one on the naturally contaminated chocolate, and one on a chocolate seeded with Bacillus subtilis, as in Example 9.

The equipment was identical to that of Example 9.

The chocolate was intimately mixed at 50° C. with 30% water. It was degassed by placing under vacuum (−0.95 bar).

It was rapidly heated to 95° C. by direct injection of food grade steam and held for 8 minutes. It was then heated under pressure by direct injection of food grade steam to 130° C., then injection was halted and the product was kept at this temperature for 5.5 minutes to sterilize it. The equivalent A_{w} of the chocolate during sterilization was 0.95.

The water was evaporated off at −0.95 bar, supplying the energy via the double envelope, until the initial A_{w} and moisture content were regained, then it was cooled to 50° C. The sugar crystal agglomerates were ground as described in Example 9.

The contamination of the naturally contaminated chocolate was <1 CFU/kg, i.e., a reduction of more than log 6, and in particular more than log 4.9 as regards sporulaceous bacteria.

The contamination of the chocolate artificially contaminated with Bacillus subtilis was reduced by log 6.1.

Thus, a milk chocolate was obtained with characteristics that were identical to the initial characteristics, but essentially sterile. Depending on the kinetics of the temperature rise and evaporation, the taste could be slightly caramelized, but there was no burned taste.

### EXAMPLES 11 TO 13

### Reduction of Microbial Flora in Dark Chocolate

The starting chocolates had the following compositions:

| | Choc 11 | Choc 12 | Choc 13 |
|---|---|---|---|
| Cocoa paste | 20.00 | 20.00 | 20.00 |
| Sugar | 22.00 | 22.00 | 22.00 |
| Cocoa butter | 57.90 | 57.45 | 57.40 |
| Lecithin | 0 | 0.25 | 0.50 |
| PGPR | 0 | 0.20 | 0 |
| Flavors | 0.10 | 0.10 | 0.10 |
| Total | 100.0 | 100.0 | 100.0 |
| % fat/DM | 69 | 69 | 69 |

Their water content was less than 0.5% with an A_{w} of <0.40.

The natural contamination was 600 CFU/g, including 61 spores of mesophilic aerobic bacteria (at 30° C.)/g. The following tests were carried out, using the same equipment as that used in Example 9.

Chocolates 11 and 12 were intimately mixed with 3% water at 50° C.

degassing was carried out under vacuum (−0.95 bar).

They were rapidly heated by direct injection of food quality steam to 126° C., injection was stopped and the product was kept at this temperature for 5.5 minutes to sterilize it. The equivalent A_{w} of the chocolate was 0.82.

Evaporation and grinding were identical to that described in Example 9.

Contamination of the artificially contaminated chocolate with Bacillus subtilis had been reduced by more than log 5.3. That of the naturally contaminated chocolate was <1 CFU/kg, i.e., a reduction of log 5.8, and in particular more than log 4.8 for sporulaceous bacteria.

Chocolate n^{o} 13 was melted at 50° C., with no added water. It was degassed by placing under vacuum (−0.95 bar).

It was rapidly heated to 126° C. by direct injection of food quality steam, injection was stopped and the product was kept at this temperature for 5.5 minutes to sterilize it. The equivalent A_{w} of the chocolate was 0.81.

Evaporation and grinding were identical to that described in Example 9.

Contamination of the artificially contaminated chocolate with Bacillus subtilis had been reduced by more than log 4.7.

Chocolate 12 was intimately mixed with 2.5% water at 50° C.

It was degassed by placing under vacuum (−0.95 bar).

It was rapidly heated to 125° C. by the double envelope, injection was stopped and the product was kept at this temperature for 30 minutes to sterilize it.

The equivalent A_{w} of the chocolate was 0.70.

Evaporation and grinding were identical to that described in Example 9.

Contamination of the chocolate artificially contaminated with Bacillus subtilis had been reduced by more than log 6.3.

Chocolate 11 was intimately mixed with 8% water at 50° C. It was degassed by placing under vacuum (−0.95 bar). It was rapidly heated to 126° C. by the double envelope, and the product was kept at this temperature for 5.5 minutes to sterilize it. The equivalent A_{w} of the chocolate was 0.83.

Evaporation and grinding were identical to that described in Example 9.

The contamination of the artificially contaminated chocolate with Bacillus subtilis was reduced by more than log 3.6.

Chocolate 11 was intimately mixed with 3% water at 50° C. It was degassed by placing under vacuum (−0.95 bar) and it was heated for 10 minutes at 80° C., then for 20 minutes to 60 minutes at 37° C. to properly distribute the water in the constituent particles of the chocolate.

It was rapidly heated to 145° C. by the double envelope, and the product was kept at this temperature for 3 minutes to sterilize it. The equivalent A_{w} of the chocolate was 0.73.

Evaporation and grinding were identical to that described in Example 9.

Contamination of the chocolate artificially contaminated with Bacillus subtilis had been reduced by more than log 3.5.

For all these tests in Example 11, a dark chocolate was obtained with characteristics that were identical to those of the starting chocolate, but essentially sterile. Depending on the kinetics of the temperature rise and evaporation, the taste could be slightly caramelized.

### EXAMPLE 14

### Reduction of Microbial Flora in a Dark Chocolate Analogue

The starting chocolate analogue had the following composition:

| | CPD 14 |
|---|---|
| Cocoa powder, 11% fat | 10.00 |
| Sugar | 22.00 |
| Hydrogenated cocoa fat | 67.35 |
| (melting point 32° C.) | |
| Lecithin | 0.3 |
| PGPR | 0.25 |
| Flavors | 0.10 |
| Total | 100.0 |
| % fat/DM | 69 |

CPD: compound

Its water content was less than 0.5% with an A_{w} of <0.40.

The following test was carried out using the same material as that described in Example 9:

Compound CPD14 was intimately mixed at 50° C. with 3% water. It was degassed by placing under vacuum (−0.95 bar).

It was rapidly heated to 130° C. by direct injection of food quality steam, injection was stopped and the product was kept at this temperature for 5 minutes to sterilize it. The equivalent A_{w} of the chocolate was 0.82.

Evaporation and grinding were identical to that described in Example 9.

Artificial contamination with Bacillus subtilis had been reduced by more than log 6.

1. A process for sterilizing a naturally or artificially contaminated food product with a low water content, characterized in that the water activity (A_{w}) of said food product is raised to a value of more than about 0.7, preferably more than 0.8, in that the hydrated food product undergoes a thermal sterilization step and in that water is eliminated so as to recover an essentially sterile food product with a low water content with a contamination, in particular of sporulaceous bacteria, at least 1000 times lower (log 3) than the contaminated starting product, and in particular less than 1 CFU/g.

2. A process for sterilizing a food product with a low water content according to claim 1, characterized in that the water activity of the starting food product is less than about 0.6, in particular of the order of about 0.4.

3. A process for sterilizing a food product with a low water content according to claim 1 or claim 2, characterized in that the water activity (A_{w}) of said food product is raised to a value of more than 0.87, in particular 0.9 to 0.96.

4. A process for sterilizing a food product with a low water content according to any one of claims 1 to 3, characterized in that degassing is carried out prior to sterilization.

5. A process for sterilizing a food product with a low water content according to any one of claims 1 to 4, characterized in that the starting food product is contaminated with sporulaceous bacteria.

6. A process for sterilizing a food product with a low water content according to any one of claims 1 to 5, characterized in that the starting food product is selected from the group formed by naturally dry fruits, sugar, or chocolate or a chocolate analogue.

7. A process for sterilizing a food product with a low water content according to any one of claims 1 to 6, characterized in that the chocolate is dark chocolate comprising at least 30% cocoa, including at least 2.5% dry defatted cocoa and at most 5% powdered milk.

8. A process for sterilizing a food product with a low water content according to claim 6, characterized in that the chocolate is milk chocolate or white chocolate.

9. A process for sterilizing a food product with a low water content according to any one of claims 6 to 8, characterized in that the water activity of the chocolate or chocolate analogue is raised to a value of more than about 0.87 by mixing a chocolate or chocolate analogue containing less than about 28% by weight of fat, or by mixing a chocolate or chocolate analogue containing more than about 48% by weight of fat, with an aqueous phase to obtain a homogeneous paste.

10. A process for sterilizing a food product with a low water content according to any one of claims 6 to 8, characterized in that the water activity of the chocolate or chocolate analogue is raised to a value of more than about 0.87 by mixing a chocolate or chocolate analogue with a water-in-oil emulsion formed from water, fat and an emulsifying agent.

11. A process for sterilizing a food product with a low water content according to any one of claims 1 to 10, characterized in that it is sterilized under pressure, preferably by heating by direct injection of food quality steam from the initial temperature in the range 40° C. to 95° C. to the sterilization temperature.

12. A process for sterilizing a food product with a low water content according to any one of claims 1 to 11, characterized in that prior to sterilization, the hydrated and optionally degassed product is held for 8 minutes to 80 minutes at a temperature in the range 30° C. to 95° C., this step possibly taking place under pressure.

13. A process for sterilizing a food product with a low water content according to any one of claims 1 to 12, characterized in that the sterilization and drying steps are carried out as a batch process in the same vessel.

14. A process for sterilizing a food product with a low water content according to any one of claims 1 to 13, characterized in that the hydrated and food product is sterilized heated by heating to a temperature in the range 100° C. to 150° C. for a suitable period, in particular in the range 1 minute to 10 minutes.

15. A process for sterilizing a food product with a low water content according to any one of claims 1 to 14, characterized in that the water is eliminated from the sterilized hydrated food product under vacuum.

16. A food product originating from a food product with a low water content contaminated by micro-organisms, characterized in that it is essentially sterile, in that it can be obtained by the process according to any one of claims 1 to 15, and in that its contamination, particularly in sporulaceous bacteria, is at least 1000 times lower than said starting contaminated food product, in particular less than 1 CFU/g.

17. A food product according to claim 16, characterized in that it is selected from the group formed by chocolate and chocolate analogues.

18. A food product according to claim 17, characterized in that it consists of a chocolate or chocolate analogue containing more than 48% fat.

19. An essentially sterile food product according to claim 17, characterized in that it consists of chocolate or a chocolate analogue comprising, as a percentage by weight:

| | |
|---|---|
| dry and defatted cocoa | 0 to 35% |
| cocoa butter or fat | 20% to 90% |
| sugar or the like | 10% to 65% |
| powdered milk, skimmed or otherwise | 0 to 30% |

20. An essentially sterile food product according to claim 17, characterized in that when said chocolate or chocolate analogue contains less than about 28% fat, sterile fat is optionally incorporated in a suitable quantity after sterilization.

21. A food product, characterized in that it is formed from an aqueous phase, in particular a milk based aqueous phase, and sterile food products according to any one of claims 16 to 20, in particular 1% to 30% with respect to the milk base.

22. A food product according to claim 21, characterized in that the solid food products are pieces of chocolate or chocolate analogue, the largest dimension of which is more than 4 mm.

23. A food composition according to claim 21 or 22, characterized in that the aqueous phase is at a neutral or weakly acidic pH and has a water activity of more than 0.8, preferably more than 0.85.

24. A food composition according to claim 23, characterized in that it is constituted by a “neutral” pH cream dessert.

25. A food composition according to claim 23, characterized in that it is constituted by a “neutral” pH mousse.
